(19) United States
(12) Patent Application Publication
(10) Pub. No.: US 2004/0175525 A1
(43) Pub. Date: Sep. 9, 2004

(54) Catheter incorporating an improved polymer shaft

(75) Inventors: Martin R. Willard, Burnsville, MN (US); Pu Zhou, Maple Grove, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: SciMed Life Systems, Inc.

(21) Appl. No.: 10/750,586

(22) Filed: Dec. 29, 2003

Related U.S. Application Data
(63) Continuation-in-part of application No. 10/377,457, filed on Feb. 28, 2003.
(60) Provisional application No. 60/361,229, filed on Feb. 28, 2002.

(51) Int. Cl. B32B 1/08

(52) U.S. Cl. 428/36.91

(57) ABSTRACT

A catheter shaft and methods of making and using the same. The catheter shaft may include a proximal portion having about 80 to about 95 weight % polyoxymethylene and about 5 to about 20 weight % polyether polyester, an intermediate portion having about 20 to about 50 weight % polyoxymethylene and about 50 to about 80 weight % polyether polyester, and a distal portion having about 5 to about 20 weight % polyoxymethylene and about 80 to about 95 weight % polyether polyester. The intermediate portion is disposed between the proximal portion and the distal portion.

### CROSS REFERENCE TO RELATED APPLICATIONS

This application is a continuation-in-part of U.S. application Ser. No. 10/377,457, filed Feb. 28, 2003, which claims the benefit of U.S. Provisional Application Serial No. 60/361,229, filed Feb. 28, 2002, the disclosures of which are incorporated herein by reference.

### FIELD OF THE INVENTION

The present invention generally relates to intravascular medical devices. More particularly, the present invention relates to intravascular catheters having improved polymer blend catheter shafts.

### BACKGROUND OF THE INVENTION

Diagnostic catheters and guide catheters are commonly used to facilitate the diagnosis and treatment of vascular diseases such as coronary artery disease and peripheral vascular disease. Balloon catheters are commonly used to treat vascular disease by dilating stenotic lesions. Because such intravascular catheters must be navigated to remote vascular sites through vascular anatomy that may be very tortuous, it may be desirable for the catheter shaft to exhibit a certain characteristic such as torqueability, trackability and pushability. A number of catheter shafts have been developed with these characteristics. Each has certain advantages and disadvantages. There is an ongoing need to provide alternative designs and methods for making and using catheter shaft with desirable characteristics and features.

### SUMMARY OF THE INVENTION

The invention provides design, material, and manufacturing method alternatives for medical devices, for example, catheter shafts. An example catheter shaft may include a polymer blend. The polymer blend may include polyoxymethylene blended with a polymer having an ether group, for example, polyether polyester. In some embodiments, the shaft may include a proximal portion, an intermediate portion, and a distal portion. Each portion may have the same or differing proportions of polyoxymethylene. The shaft may also include an inner layer and an outer layer, each of which may have the same or differing proportions of polyoxymethylene. These and some of the other features and characteristics of suitable catheter shafts are described in more detail below.

The above summary of some embodiments is not intended to describe each disclosed embodiment or every implementation of the present invention. The Figures, and Detailed Description which follow more particularly exemplify these embodiments.

### BRIEF DESCRIPTION OF THE DRAWINGS

The invention may be more completely understood in consideration of the following detailed description of various embodiments of the invention in connection with the accompanying drawings in which:

FIG. 1 is a plan view of an example catheter;

FIG. 2 is a cross-sectional view of the catheter of FIG. 1 taken along line 2-2;

FIG. 3 is a longitudinal sectional view of the catheter of FIG. 1 taken along line 3-3;

FIG. 4 is a plan view of another example catheter, shown as a balloon catheter; and

FIG. 5 is a cross-sectional view of the catheter of FIG. 4 taken along line 5-5.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION OF THE INVENTION

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

Weight percent, percent by weight, wt%, wt-%, % by weight, and the like are synonyms that refer to the concentration of a substance as the weight of that substance divided by the weight of the composition and multiplied by 100.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The drawings, which are not necessarily to scale, depict illustrative embodiments and are not intended to limit the scope of the invention.

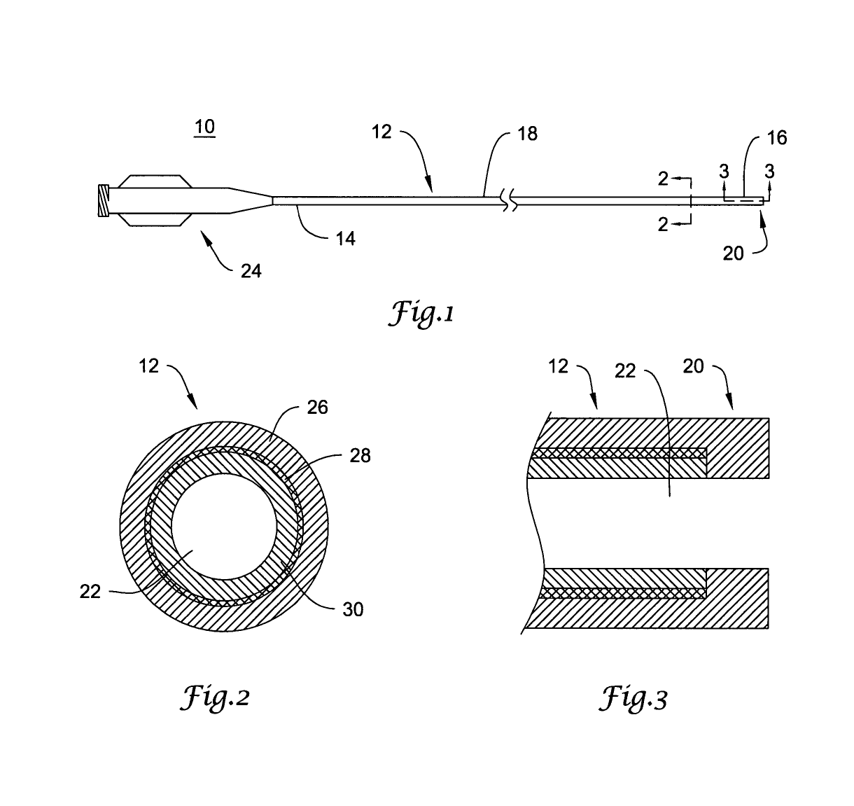

FIG. 1 illustrates an example embodiment of a catheter 10. Catheter 10 may include a catheter shaft 12 having a proximal region 14, a distal region 16, an intermediate region 18 disposed between the proximal and distal regions 14/16, and a distal tip 20 disposed adjacent distal region 16. Distal region 16, intermediate region 18, distal tip 20, or any other suitable region of shaft 12 may be curved depending on the particular clinical application. Shaft 12 may include a lumen 22 (best seen in FIG. 2) extending therethrough, which may be used, for example, to facilitate insertion of other medical devices (e.g., guidewires, balloon catheters, etc.) therethrough, and/or to facilitate injection of fluids (e.g., radiopaque dye, saline, drugs, etc.) therethrough. A manifold 24 can be connected to proximal section 14 of shaft 12 to facilitate connection to other medical devices (e.g., syringe, Y-adapter, etc.) and to provide access to the lumen 22. For purposes of illustration and discussion only, the intravascular catheter shown in FIG. 1 is in the form of a guide or diagnostic catheter 10, but may comprise virtually any catheter used for intravascular applications including balloon catheters, micro catheters, and the like.

Catheter 10 may have a length and an outside diameter sufficient to enable intravascular insertion and navigation. For example, catheter 10 may have a length of approximately 100 cm to 150 cm and an outside diameter of approximately 4 to 9 French. The different sections of catheter may have various lengths. For example, proximal section 14 of shaft 12 may be from about 60 to about 135 cm or about 60 to about 90% of the total length. Intermediate section 18 of shaft 12 may be from about 15 to about 30 cm or about 15 to about 20% of the total length. Distal section 16 of shaft 12 may be from about 2 to about 10 cm or about 2 to about 7% of the total length.

Shaft 12, or sections thereof, may be manufactured from or otherwise include a polymer blend. The polymer blend generally includes polyoxymethylene blended with a polymer having an ether group or moiety. For example, the polymer blend may include polyoxymethylene blended with a polyether polyester such as ARNITEL® available from DSM Engineering Plastics or HYTREL® available from DuPont. Other suitable polymers that may be blended with polyoxymethylene include polyether block ester, polyether block amide (PEBA, for example available under the trade name PEBAX®), polyetheretherketone (PEEK), polyetherimide (PEI), and the like. A suitable polyoxymethylene is commercially available under the trade name Delrin™ commercially available from DuPont Wilmington, Del.

Proximal section 14, intermediate section 18 and distal section 16 may each be formed with the same polymer blend. Alternatively, each section may be made from a different blend. The different blends may have differing amounts of polyoxymethylene and polyether polyester. For example, proximal section 14 may have about 80 to about 95 weight % polyoxymethylene and about 5 to about 20 weight % polyether polyester. Intermediate section 18 can have about 20 to about 50 weight % polyoxymethylene and about 50 to about 80 weight % polyether polyester. Distal section 16 can have about 5 to about 20 weight % polyoxymethylene and about 80 to about 95 weight % polyether polyester. In an alternative embodiment, distal section 16 can include about 0 to about 5 weight % polyoxymethylene and about 95 to about 100 weight % polyether polyester.

Proximal section 14, intermediate section 18 and distal section 16 may each have a different flexural modulus. For example, proximal section 14 can have a flexural modulus of about 210 to about 380 ksi. Intermediate section 18 can have a flexural modulus of about 30 to about 90 ksi. Distal section 16 can have a flexural modulus of less than about 30 ksi or from about 1 to about 30 ksi or from about 15 to about 30 ksi. The differences in flexural modulus can be varied, for example, by altering the proportion of polyoxymethylene and polyether polyester. For example, the flexural modulus can be decreased by increasing the amount of polyether polyester and/or decreasing the amount of polyoxymethylene. It can be appreciated that variations in flexural modulus can be made without departing from the spirit of the invention.

Manufacturing the polymer blended sections 14/16/18 may include extrusion of a polyoxymethylene pre-blend or by co-extrusion of the polyoxymethylene with the polyether polyester such as by interrupted layer co-extrusion (ILC). Alternatively, the sections 14/16/18 may be formed of separate extruded tubular segments subsequently fused together. In some embodiments, shaft 12 (i.e., sections 14/16/18) may include a single layer of polymer blend. According to these embodiments, the polymer blend can be extruded over a suitable die or mandrel. It can be appreciated that a number of other known manufacturing methods may be utilized without departing from the spirit of the invention.

In other embodiments, sections 14/16/18 may have a multi-layer construction. For example, shaft 12 may include a polymer blend outer layer 26, a reinforcement layer 28 and an inner layer 30 as shown in FIG. 2. Outer layer 26 may generally span sections 14/16/18 and be made from a polymer blend as described above. For example, outer layer 26 may have may have about 80 to about 95 weight % polyoxymethylene and about 5 to about 20 weight % polyether polyester adjacent proximal section 14, about 20 to about 50 weight % polyoxymethylene and about 50 to about 80 weight % polyether polyester adjacent intermediate section 18, and about 5 to about 20 weight % polyoxymethylene and about 80 to about 95 weight % polyether polyester adjacent distal section 16. Moreover, outer layer 26 may be manufactured utilizing the extrusion techniques described above.

Reinforcement layer 28 may comprise a braid, coil, or other suitable reinforcing structure. Reinforcement layer 28 may be made from a number of different materials including metals, metal alloys, polymers, metal-polymer composites, and the like, or any other suitable material. Some examples of suitable metals and metal alloys include stainless steel, such as 304V, 304L, and 316L stainless steel; nickel-titanium alloy such as linear-elastic or super-elastic nitinol, nickel-chromium alloy, nickel-chromium-iron alloy, cobalt alloy, tungsten or tungsten alloys, MP35-N (having a composition of about 35% Ni, 35% Co, 20% Cr, 9.75% Mo, a maximum 1% Fe, a maximum 1% Ti, a maximum 0.25% C, a maximum 0.15% Mn, and a maximum 0.15% Si), hastelloy, monel 400, inconel 825, or the like; or other suitable material.

In some embodiments, reinforcement layer 28 may be made from or otherwise include a radiopaque material. Radiopaque materials are understood to be materials capable of producing a relatively bright image on a fluoroscopy screen or another imaging technique during a medical procedure. This relatively bright image aids the user of catheter 10 in determining its location. Some examples of radiopaque materials can include, but are not limited to, gold, platinum, palladium, tantalum, tungsten alloy, plastic material loaded with a radiopaque filler, and the like.

Inner layer 30 may include a lubricious, a hydrophilic, a protective, or other type of material or coating. Hydrophobic materials or coatings such as fluoropolymers provide a dry lubricity which improves guidewire handling and device exchanges. Lubricious coatings improve steerability and improve lesion crossing capability. Suitable lubricious polymers are well known in the art and may include silicone and the like, hydrophilic polymers such as high-density polyethylene (HDPE), polytetrafluoroethylene (PTFE), polyarylene oxides, polyvinylpyrolidones, polyvinylalcohols, hydroxy alkyl cellulosics, algins, saccharides, caprolactones, and the like, and mixtures and combinations thereof. Hydrophilic polymers may be blended among themselves or with formulated amounts of water insoluble compounds (including some polymers) to yield coatings with suitable lubricity, bonding, and solubility. Some other examples of such coatings and materials and methods used to create such coatings can be found in U.S. Pat. Nos. 6,139,510 and 5,772,609, which are incorporated herein by reference. Alternatively, inner layer 30 may comprise a polyoxymethylene homopolymer or a polyoxymnethylene blend as discussed herein.

Distal tip 20 may have a number of different forms or configurations. For example, distal tip 20 may be defined by a region where outer layer 26 extends beyond inner layer 30 and reinforcement layer 28 to define a soft atraumatic tip. In some embodiments, distal tip 20 may have essentially the same material composition as the adjacent portion of outer layer 26. For example, distal tip 20 includes a polymer blend having about 5 to about 20 weight % polyoxymethylene and about 80 to about 95 weight % polyether polyester. Alternatively, distal tip 20 may be made from a different material and fuised to or co-extruded with outer layer 26. For example, distal tip 20 may be made from polyether polyester or another suitable (e.g., “soft”) polymer.

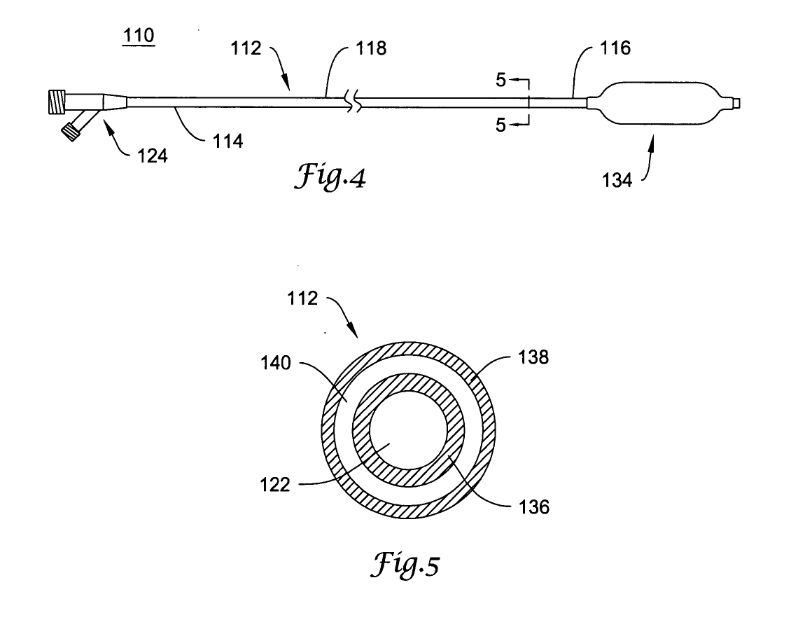

FIG. 4 illustrates another example catheter 110 in the form of an intravascular balloon catheter. Catheter 110 includes shaft 112 having proximal portion 114, distal portion 116, and intermediate portion 118 disposed between proximal portion 114 and distal portion 116. An inflatable balloon 134 is connected to distal portion 118 of shaft 112. Depending on the type (over-the-wire, fixed-wire, single-operator-exchange, etc.) of balloon catheter 110, all or a portion of shaft 112 may include an inner tube 136 defining a guidewire lumen 122 therein, and an outer tube 138 disposed thereon to define an annular inflation lumen 140 therebetween. A manifold 124 can be connected to the proximal end of proximal portion 114 of shaft 112 to facilitate connection to other medical devices (e.g., syringe, Y-adapter, etc.) and to provide access to lumen 122 and/or 140.

Inner tube 136 may comprise a lubricious polymer similar to those describe above in relation to inner layer 30. For example, inner tube 136 may comprise HDPE or PTFE. Outer tube 138 may comprise a polymer blend that is similar to or the same as the polymer blends of the outer layer 26 discussed above. In addition, the manufacture and arrangement of parts for outer tube 138 may be similar to or the same as that discussed with reference to the outer layer 26.

It should be understood that this disclosure is, in many respects, only illustrative. Changes may be made in details, particularly in matters of shape, size, and arrangement of steps without exceeding the scope of the invention. The invention's scope is, of course, defined in the language in which the appended claims are expressed.

What is claimed is:

1. A catheter shaft, comprising:
a proximal portion having about 80 to about 95 weight % polyoxymethylene and about 5 to about 20 weight % polyether polyester;
an intermediate portion coupled to the proximal portion, the intermediate portion having about 20 to about 50 weight % polyoxymethylene and about 50 to about 80 weight % polyether polyester; and
a distal portion coupled to the intermediate portion, the distal portion having about 5 to about 20 weight % polyoxymethylene and about 80 to about 95 weight % polyether polyester.

2. The catheter shaft according to claim 1, further comprising an inner polytetrafluoroethylene tubular member disposed within the polymer blend shaft.

3. The catheter shaft according to claim 2, further comprising a braided metallic support member disposed between the inner polytetrafluoroethylene tubular member and the polymer blend shaft.

4. The catheter shaft according to claim 1, wherein the proximal portion, intermediate portion and distal portion define a total shaft length and the proximal portion is about 60 to about 90% of the total length, the intermediate portion is about 15 to about 20% of the total length, and the distal portion is about 2 to about 7% of the total length.

5. The catheter shaft according to claim 1, further comprising a distal tip coupled to the distal portion of the catheter shaft.

6. The catheter shaft according to claim 5, wherein the distal tip is comprised of polyether polyester.

7. A catheter shaft comprising:
a polymer blend shaft that includes a blend of polyoxymethylene with polyether polyester, the polymer blend shaft including a proximal portion having a flexural modulus of about 210 to about 380 ksi, an intermediate portion having a flexural modulus of about 30 to about 90 ksi, and a distal portion having a flexural modulus of less than about 30 ksi, wherein the intermediate portion is disposed between the proximal portion and the distal portion.

8. The catheter shaft according to claim 7, further comprising an inner polytetrafluoroethylene tubular member disposed within the polymer blend shaft.

9. The catheter shaft according to claim 8, further comprising a braided metallic support member disposed between the inner polytetrafluoroethylene tubular member and the polymer blend shaft.

10. The catheter shaft according to claim 8, wherein the proximal portion, intermediate portion and distal portion define a total shaft length and the proximal portion is about 60 to about 90% of the total length, the intermediate portion is about 15 to about 20% of the total length, and the distal portion is about 2 to about 7% of the total length.

11. The catheter shaft according to claim 8, wherein the proximal portion includes about 80 to about 95 weight % polyoxymethylene and about 5 to about 20 weight % polyether polyester, the intermediate portion includes about 20 to about 50 weight % polyoxymethylene and about 50 to about 80 weight % polyether polyester, and the distal portion includes about 5 to about 20 weight % polyoxymethylene and about 80 to about 95 weight % polyether polyester.

12. A catheter shaft, comprising:
an inner layer;
a support member disposed over the inner layer; and
an outer layer disposed over the inner tubular member, the outer layer including a proximal portion having about 80 to about 95 weight % polyoxymethylene and about 5 to about 20 weight % polyether polyester, an intermediate portion having about 20 to about 50 weight % polyoxymethylene and about 50 to about 80 weight % polyether polyester, and a distal portion having about 5 to about 20 weight % polyoxymethylene and about 80 to about 95 weight % polyether polyester, wherein the intermediate portion is disposed between the proximal portion and the distal portion.

13. The catheter shaft according to claim 12, wherein the inner layer comprises polytetrafluoroethylene.

14. The catheter shaft according to claim 12, wherein the inner layer comprises high-density polyethylene.

15. The catheter shaft according to claim 12, wherein the support member includes a braid.

16. The catheter shaft according to claim 12, wherein the support member includes a coil.

17. The catheter shaft according to claim 12, further comprising a distal tip coupled to and disposed distally of the inner layer, outer layer, and support member.

18. The catheter shaft according to claim 17, wherein the distal tip is comprised of polyether polyester.

19. A balloon catheter comprising:
an inner tubular member;
an outer tubular member disposed over the inner tubular member, the outer tubular member including a proximal portion having about 80 to about 95 weight % polyoxymethylene and about 5 to about 20 weight % polyether polyester, an intermediate portion having about 20 to about 50 weight % polyoxymethylene and about 50 to about 80 weight % polyether polyester, and a distal portion having about 5 to about 20 weight % polyoxymethylene and about 80 to about 95 weight % polyether polyester, wherein the intermediate portion is disposed between the proximal portion and the distal portion; and
a balloon coupled to the distal portion of the outer tubular member.

20. The balloon catheter according to claim 19, wherein the inner tubular member comprises polytetrafluoroethylene.

21. The balloon catheter according to claim 19, wherein the inner tubular member comprises high-density polyethylene.

22. The balloon catheter according to claim 19, wherein the inner tubular member defines a guidewire lumen extending therethrough.

23. The balloon catheter according to claim 19, wherein an inflation lumen is defined between the inner tubular member and the outer tubular member.

24. A catheter shaft, comprising:
a polymer blend proximal section;
a polymer blend distal section having a material composition different from the proximal section;
a polymer blend intermediate section disposed between the proximal section and the distal section, the intermediate section having a material composition different from both the proximal section and the distal section; and
wherein the proximal section, the distal section, and the intermediate section each include polyoxymethylene blended with a polymer having an ether group.

25. A catheter shaft, comprising:
a proximal section including about 80 to about 95 weight % polyoxymethylene;
an intermediate section coupled to the proximal section, the intermediate section including about 20 to about 50 weight % polyoxymethylene;
a distal section coupled to the intermediate section, the distal section having about 5 to about 20 weight % polyoxymethylene; and
wherein the proximal section, intermediate section, and distal section each include polyether polyester.

26. A method for manufacturing a catheter shaft, comprising the steps of:
providing a first polymer blend having about 80 to about 95 weight % polyoxymethylene and about 5 to about 20 weight % polyether polyester;
providing a second polymer blend having about 20 to about 50 weight % polyoxymethylene and about 50 to about 80 weight % polyether polyester; and
providing a third polymer blend having about 5 to about 20 weight % polyoxymethylene and about 80 to about 95 weight % polyether polyester;
extruding the first polymer blend to define a first shaft member;
extruding the second polymer blend to define a second shaft member;
extruding the third polymer blend to define a third shaft member; and
coupling the first shaft member, second shaft member, and third shaft member to define a catheter shaft.

27. A method for manufacturing a catheter shaft, comprising the steps of:
providing a first quantity of polyoxymethylene;
providing a second quantity of polyether polyester;
co-extruding the first quantity of polyoxymethylene with the second quantity of polyether polyester to define a proximal shaft portion having about 80 to about 95 weight % polyoxymethylene and about 5 to about 20 weight % polyether polyester, an intermediate shaft portion having about 20 to about 50 weight % polyoxymethylene and about 50 to about 80 weight % polyether polyester, and a distal shaft portion having about 5 to about 20 weight % polyoxymethylene and about 80 to about 95 weight % polyether polyester.
